(19) United States
(12) Patent Application Publication
(10) Pub. No.: US 2018/0300918 A1
(43) Pub. Date: Oct. 18, 2018

(54) WEARABLE DEVICE AND METHOD FOR DISPLAYING EVACUATION INSTRUCTION

(71) Applicant: Tsinghua University, Beijing (CN)

(72) Inventors: Chao ZHANG, Beijing (CN); Qingshan JIA, Beijing (CN); Hongkun LI, Beijing (CN)

(21) Appl. No.: 15/686,245

(22) Filed: Aug. 25, 2017

(30) Foreign Application Priority Data
Apr. 13, 2017 (CN) 201710239711.8

(51) Int. Cl. G06T 11/60; G06F 3/01; G10L 13/04; G02B 27/01

(52) U.S. Cl. CPC G06T 11/60; G06F 3/012; H04N 5/23293; G02B 27/0172; G10L 13/043

(57) ABSTRACT

A wearable device and a method for displaying an evacuation instruction are provided by embodiments of the present disclosure. The wearable device includes an eyeglass frame; a camera, configured to capture a current scene; an eyeglass lens with a display screen; a rotating vector sensor, configured to acquire a current horizontal orientation angle; a geomagnetic sensor, configured to acquire a current geomagnetic deviation angle; and a processor. The processor is configured to compute a current orientation angle according to the current horizontal orientation angle and the current geomagnetic deviation angle, to acquire an evacuation orientation angle, to acquire a direction angle according to the current orientation angle and the evacuation orientation angle, to convert the direction angle into a visual guide identifier, and to display the visual guide identifier in the current scene shown on the display screen.

### CROSS-REFERENCE TO RELATED APPLICATIONS

This application claims priority to and benefits of Chinese Patent Application No. 201710239711.8, filed on Jan. 9, 2017, the entire content of which is incorporated herein by reference.

### TECHNICAL FIELD

The present disclosure relates to the field of building evacuation and guiding technology, and more particularly, to a device and a method for displaying an evacuation instruction to those in the building by showing evacuation directions based on a portability and visibility of a wearable device.

### BACKGROUND

Now, evacuation instructions in buildings are unchangeable generally, which may not show current situations when an urgent event happens.

### SUMMARY

Embodiments of the present disclosure provide a wearable device for displaying an evacuation instruction. The wearable device includes: an eyeglass frame; a camera, configured to capture a current scene; an eyeglass lens with a display screen, in which the display screen is configured to display the current scene; a rotating vector sensor, configured to acquire a current horizontal orientation angle; a geomagnetic sensor, configured to acquire a current geomagnetic deviation angle; and a processor. The eyeglass lens, the camera, the rotating vector sensor and the geomagnetic sensor are arranged on the eyeglass frame. The processor is configured to compute a current orientation angle according to the current horizontal orientation angle and the current geomagnetic deviation angle, to acquire an evacuation orientation angle, to acquire a direction angle according to the current orientation angle and the evacuation orientation angle, to convert the direction angle into a visual guide identifier, and to display the visual guide identifier in the current scene shown on the display screen, such that a user moves according to the visual guide identifier and the current scene.

Embodiments of the present disclosure provide a method for displaying an evacuation instruction. The method is performed by a processor of a wearable device and includes: acquiring a current horizontal orientation angle; acquiring a current geomagnetic deviation angle; computing a current orientation angle according to the current horizontal orientation angle and the current geomagnetic deviation angle; acquiring an evacuation orientation angle; acquiring a direction angle according to the current orientation angle and the evacuation orientation angle; and converting the direction angle into a visual guide identifier; and displaying the visual guide identifier in a current scene shown on a display screen of the wearable device, such that a user moves according to the visual guide identifier and the current scene.

Embodiments of the present disclosure provide a non-transitory computer-readable storage medium, having stored therein instructions that, when executed by a processor of a wearable device, causes the wearable device to perform a method for displaying an evacuation instruction. The method includes: acquiring a current horizontal orientation angle; acquiring a current geomagnetic deviation angle; computing a current orientation angle according to the current horizontal orientation angle and the current geomagnetic deviation angle; acquiring an evacuation orientation angle; acquiring a direction angle according to the current orientation angle and the evacuation orientation angle; and converting the direction angle into a visual guide identifier; and displaying the visual guide identifier in a current scene shown on a display screen of the wearable device, such that a user moves according to the visual guide identifier and the current scene.

### BRIEF DESCRIPTION OF THE DRAWINGS

FIG. 1 is a schematic diagram illustrating a wearable device according to embodiments of the present disclosure.

FIG. 2 is a diagram illustrating content shown on a display screen of a wearable device according to embodiments of the present disclosure.

FIG. 3 is a schematic diagram illustrating an orientation angle according to embodiments of the present disclosure.

FIG. 4 is a flow chart illustrating a method for displaying an evacuation instruction according to embodiments of the present disclosure.

### DETAILED DESCRIPTION

A wearable device for displaying an evacuation instruction and a method for displaying an evacuation instruction according to embodiments of the present disclosure will be described with reference to the drawings.

In embodiments, taking an office building as an example for illustrative purposes, a server is set in regions that are insusceptible to disasters. For example, the server is set outside the office building or in a basement of the office building. Information including a plat of the office building is pre-stored in the server. A function of the server is to communicate with the wearable device via Internet so as to acquire a location of the wearable device and to send a current evacuation orientation instruction to the wearable device. The server may provide an optimal evacuation orientation instruction for the user of the wearable device according to a current location of the user (or the wearable device), current locations of others in the office building, a location of the disaster and the like. The evacuation orientation instruction includes an evacuation orientation angle, which refers to an absolute direction of an evacuation exit with respect to the user and is denoted by an orientation angle with respect to Geographic North. The server and the method for generating the evacuation instruction may be understood with reference to the related arts, which are not elaborated herein.

The wearable device according to embodiments of the present disclosure has a capacity of displaying an evacuation instruction, and is developed on the daily wearable device. In embodiments, the wearable device is a head-wearable device, such as glasses, helmets and so on.

The wearable device for displaying an evacuation instruction according to embodiments of the present disclosure is improved based on conventional wearable glasses, thus having a similar shape and a similar wear-manner to the conventional wearable glasses. As illustrated in FIG. 1, the wearable device includes an eyeglass frame 1, an eyeglass lens with a display screen 2, a camera 3, a speech player (not illustrated), a battery (not illustrated), a switch 4, and a micro-processor chip (not illustrated) that is configured to access to Internet and to process data. In an embodiment, the micro-processor chip may be replaced with a micro-processor.

The camera 3, the speech player, the battery, the switch 4 and the micro-processor chip (or the micro-processor) are arranged on the eyeglass frame 1.

In an embodiment, the wearable device also includes a rotating vector sensor 5 and a geomagnetic sensor 6.

A plat of a locale where the user is located is pre-stored in the micro-processor chip. In addition, the wearable device also includes application programs for converting the evacuation orientation instruction acquired or generated into a visual guide identifier, which may also be stored in the micro-processor chip.

The display screen 2 is connected to the camera 3. The camera 3, the speech player, the rotating vector sensor 5, the geomagnetic sensor 6, the battery and the switch 4 each is connected to the micro-processor chip.

Now, the above wearable device will be described in detail.

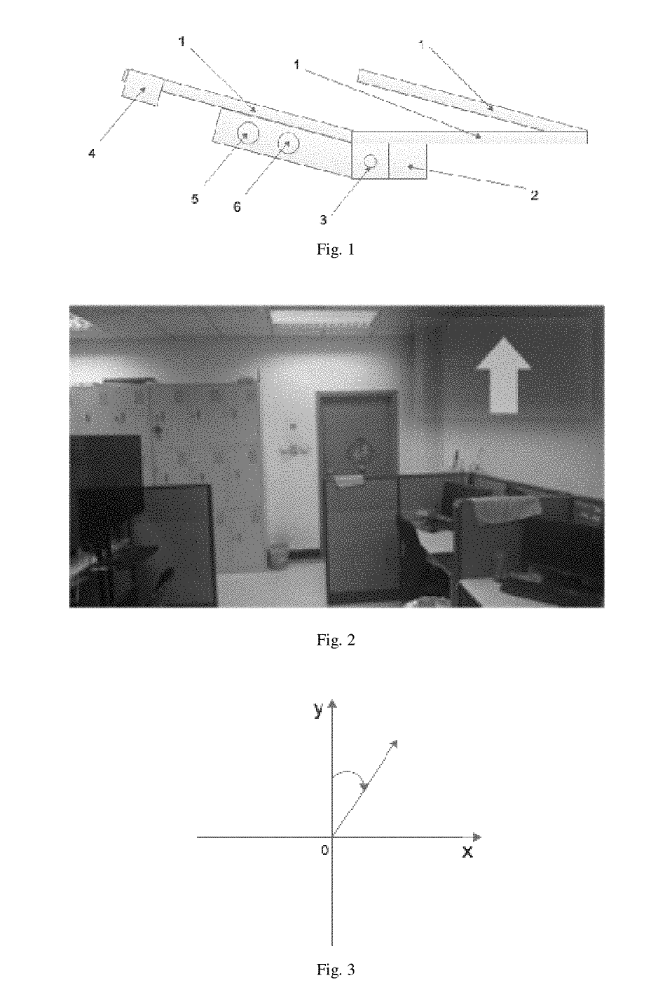

The display screen 2 is mainly configured to display a current vision or a current scene of the user's eyes and an evacuation identifier. In embodiments, an Arrow is employed as the evacuation identifier. Content of the display screen 2 is illustrated as FIG. 2. Background illustrated on the display screen 2 is the current scene captured by the camera 3. At a top right corner of the display screen 2, an arrow indicating a current evacuation orientation is displayed. In embodiments, the color of the arrow is green. The arrow may orientate four directions, such as right forwards, right backwards, right leftwards and right rightwards.

The speech player is configured to play a prompt speech. When the direction of the arrow shown on the display screen changes, the speech player is controlled by the micro-processor chip to play the prompt speech to prompt the user. Content of the prompt speech corresponds to a respect direction of the arrow. When the direction of the arrow changes to right forwards, the content of the prompt speech is “move forwards”. When the direction of the arrow changes to right backwards, the content of the prompt speech is “turn backwards”. When the direction of the arrow changes to right leftwards, the content of the prompt speech is “turn leftwards”. When the direction of the arrow changes to right rightwards, the content of the prompt speech is “turn rightwards”.

The rotating vector sensor 5 is configured to acquire a current horizontal orientation angle of the user's head with respect to Geographic North at a present moment.

The geomagnetic sensor 6 is configured to acquire a current geomagnetic deviation angle of the user's head at a present moment.

The micro-processor chip may communicate with the server via the pre-stored application programs, to acquire the evacuation orientation instruction, to convert the evacuation orientation instruction into the visual guide identifier, and to control the speech player to play the prompt speech corresponding to the visual guide identifier. The application programs may employ conventional programming techniques. In detail, the application programs include: a display module, a speech prompt module, an instruction managing module, an orientation module and a network connection module. Now details and implementation of each module will be described.

The orientation module is configured to acquire a current orientation angle of the user's head with respect to the Geographic North according to the current horizontal orientation angle of the user's head with respect to the Geographic North acquired via the rotating vector sensor and the current geomagnetic deviation angle of the user's head acquired via the geomagnetic sensor, such that an orientation of the user's head may be corrected. In detail, the current orientation angle may be acquired by followings. The current horizontal orientation angle of the user's head with respect to the Geographic North is acquired via the rotating vector sensor, and is denoted as a; the current geomagnetic deviation angle of the user's head is acquired via the geomagnetic sensor, and is denoted as b; and the current orientation angle of the user's head with respect to the Geographic North is acquired and is denoted as x, that is x=a+b.

The term “orientation angle with respect to the Geographic North” is defined as illustrated in FIG. 3. The y axis directs to the North and the x axis directs to the East. The “orientation angle with respect to the Geographic North” is an angle formed by a terminate side of y axis and a rotatable side. It is defined that the angle with the rotatable side overlapping the y axis (which is towards to the North) is 0, and the angle increases as the rotatable side is away from the y axis clockwise. The angle ranges from 0 to 360. The orientation angle with respect to the Geographic North illustrated in FIG. 3 is 30 degree.

The network connection module employs WebSocket as an application layer protocol to keep connecting with the server, to maintain online and offline states, and to store the information of the plat of the locale where the user is located. The network connection module exchanges the data with the server via a JSON format. Specific working processes of the network connection module are described in detail. The network connection module keeps connecting with the server, to upload the location of the user and to receive the evacuation orientation instruction. If the network is disconnected, that is the network connection module is unable to communication with the server, the network connection module may generate an offline evacuation orientation instruction according to the location of the user and offline-stored information of the plat. The method for acquiring the evacuation orientation instruction and the method for generating the evacuation orientation instruction may be understood with reference to the related arts, which are not elaborated herein.

The network connection module may acquire the evacuation orientation instruction from the server preferentially. This is because the server may acquire locations of all users and the location of the disaster in the locale, such that the server may provide an optimized evacuation orientation instruction for the user to avoid congestions. When the network is unable to be connected, the locally generated evacuation orientation instruction may guide the user to a closest exit.

The instruction managing module may generate a text evacuation instruction according to the information provided by the orientation module and the network connection module. For example, the information provided by the orientation module is that an orientation of the user' head is the North, the information provided by the network connection module is that the evacuation direction is the East, then, the instruction manage module is configured to generate the text evacuation instruction of “turn rightwards” according to two pieces of information, and to send the text evacuation instruction to the speech prompt module and the display module.

The speech prompt module is configured to convert the text evacuation instruction into the speech prompt by using a speech synthesis technique, and to play the speech prompt. The content of the speech prompt is one of “move forwards”, “turn backwards”, “turn leftwards” and “turn rightwards” each corresponding to the direction of the arrow.

The display module is configured to convert the text evacuation instruction provided by the instruction manage module into a visual graphic to display the visual graphic. If there is not a new instruction, the application programs may be in a circular wait state.

Each module of embodiments of the present disclosure may be written in Java.

With the wearable device according to embodiments of the present disclosure, by acquiring the current horizontal orientation angle, by acquiring the current geomagnetic deviation angle, by acquiring the evacuation orientation angle, and by acquiring the direction angle, a precious guide may be achieved and the evacuation has a high efficiency. Thus, problems of losing sight of evacuation signs and of congestions in the building are solved.

The wearable device is characteristic of being easy to wear and information displaying directly, and is helpful to display the evacuation instruction.

The wearable device may access to the Internet via wireless, so as to receive evacuation instruction in real time. When a disaster occurs, although basic facilities may be destroyed, evacuations and guides by means of the wearable device may be not influenced.

The wearable device may directly display images to the user at the front of eyes, such that it may be difficult for the user to lose sight of the evacuation instruction. The evacuation instruction is displayed by means of green arrows which are sensitive for the user. With the geomagnetic sensor and the rotating vector sensor (such as an inertial sensor) included in the wearable device, when the orientation of the user' head changes, the evacuation orientation may be adjusted based thereupon to direct to a correct direction.

The wearable device may provide the user with the evacuation instruction in speech. With a visual guide is on, as a useful complementation and copy, a speech guide helps the user to calm down and to move according to the evacuation instruction.

The evacuation direction provided by the wearable device is personalized and global. The wearable device may acquire the location of the user by using the camera. A most suitable evacuation instruction for the user may be acquired according to the location of the user. Moreover, locations of other users may be acquired via the Internet to guide the evacuation, to avoid congestions.

The wearable device according to embodiments of the present disclosure has following benefits. The evacuation information may be displayed in real time to realize a personalized guide. The evacuation information may be displayed in the front of the user's eyes, such that the user may not look around for evacuation signs. It may be realized to prompt in speech, such that the emotion of the user may be released and it is helpful for those with vision disorders. The congestion may be avoided by using global information.

Embodiments of the present disclosure also provide a method for displaying an evacuation instruction on a wearable device. For example, the wearable device may be described above, which is not elaborated herein. The method includes two modes, one is an online mode and the other is an offline mode. Processes of the two modes are substantial same, but the online mode is that the network is connected and an evacuation instruction is acquired from a server, while the offline mode is that the network is disconnected, and the evacuation orientation instruction is generated locally. It is to be illustrated that, the processes of the method according to embodiments of the present disclosure described herein are merely the processes at a certain moment. When information of sensors and/or the evacuation orientation instruction change, the processes may be updated.

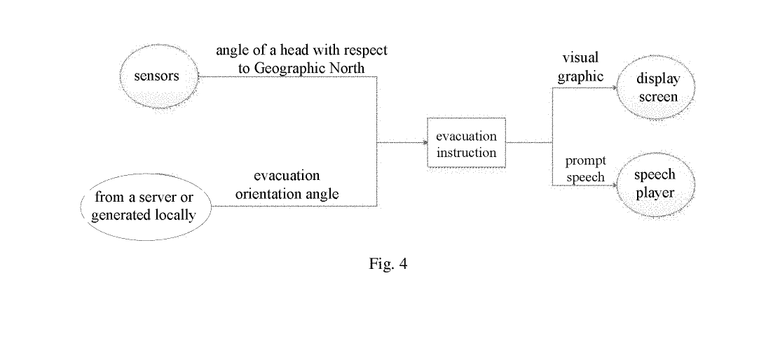

The processes of the method are illustrated as FIG. 4, including followings.

A current horizontal orientation angle of a user' head with respect to Geographic North is acquired by a rotating vector sensor and is denoted as a.

A current geomagnetic orientation angle of the user' head is acquired by a geomagnetic sensor, and is denoted as b.

A current orientation angle of the user's head with respect to the Geographic North is acquired and is denoted as x, that is x=a+b.

When the network is connected, the evacuation orientation instruction is acquired from the server; when the network is disconnected, the evacuation orientation instruction is generated locally. The evacuation orientation instruction includes an evacuation orientation angle that is an orientation angle with respect to the Geographic North.

In embodiments, the evacuation orientation instruction is acquired from the server via the Internet.

The current orientation angle x of the user' head with respect to the Geographic North and the instruction of the orientation direction are synthesized to obtain a text evacuation instruction. In embodiments, the text evacuation instruction is a direction angle. In detail, the text evacuation instruction may be obtained by followings.

The orientation angle of the user's head with respect to the Geographic North is denoted as x, and the evacuation direction angle is denoted as y, a difference therebetween is calculated and is denoted as i, that is i=x−y. A complementation operation is performed on the difference i to obtain a mid-result o, that is o=i %360. The mid-result o ranges from 0 to 360. And the operation “%” is the complementation operation. If there is more than one remainder, a positive remainder is selected as the mid-result. For example, −340%360=20 or −340%360=−340, then the result “20” is selected as the mid-result.

When the mid-result o is within different value range, the text evacuation instruction generated is different. For example, when the mid-result o is within the value range from 0 to 45 or from 315 to 360, the text evacuation instruction representing “move forwards” is generated. When the mid-result o is within the value range from 45 to 135, the text evacuation instruction representing “turn rightwards” is generated. When the mid-result o is within the value range from 135 to 225, the text evacuation instruction representing “turn backwards” is generated. When the mid-result o is within the value range from 225 to 315, the text evacuation instruction representing “turn leftwards” is generated.

The text evacuation instruction is converted into a speech prompt by using a speech synthesis technique, and the speech prompt is sent to the speech player, such that the speech prompt is played by the speech player.

The text evacuation instruction is converted into a visual graphic by using a characteristic processing technique, and the visual graphic is sent to a display screen such that the visual graphic is displayed by the display screen.

In embodiments, the visual graphic is an arrow. The arrow is displayed on a top right corner of the display screen after the display screen receives the visual graphic. The speech prompt is played when a direction of the arrow alters after the speech player receives direction information of the arrow.

The embodiments may be implemented in detail as follow.

When a disaster occurs, the user may wear glasses for displaying an evacuation instruction and may switch the supply power on. If the network may be connected, the glasses communicate with the server, upload its location and acquire the evacuation orientation instruction. If the network may not be connected, that is the glasses is unable to communicate with the server, the glasses may locally generate the evacuation orientation instruction according to its location. Then, the scene illustrated as FIG. 2 may be displayed on the display screen. The background displayed on the display screen is a view of the user. An arrow is illustrated at the top right corner for guiding the user to move. When the direction of the arrow changes, the speech player may play the speech prompt.

The display screen may guide the user continuous until the user arrivals to a designated destination with the help of the evacuation orientation instruction provided by the glasses.

What is claimed is:

1. A wearable device for displaying an evacuation instruction, comprising:
an eyeglass frame;
a camera, configured to capture a current scene;
an eyeglass lens with a display screen, wherein the display screen is configured to display the current scene;
a rotating vector sensor, configured to acquire a current horizontal orientation angle;
a geomagnetic sensor, configured to acquire a current geomagnetic deviation angle; and
a processor,
wherein the eyeglass lens, the camera, the rotating vector sensor and the geomagnetic sensor are arranged on the eyeglass frame;
the processor is configured to compute a current orientation angle according to the current horizontal orientation angle and the current geomagnetic deviation angle, to acquire an evacuation orientation angle, to acquire a direction angle according to the current orientation angle and the evacuation orientation angle, to convert the direction angle into a visual guide identifier, and to display the visual guide identifier in the current scene shown on the display screen, such that a user moves according to the visual guide identifier and the current scene.

2. The wearable device according to claim 1, further comprising:
a speech player;
wherein the processor is further configured to convert the visual guide identifier into a speech instruction and to transmit the speech instruction to the speech player to play the speech instruction.

3. The wearable device according to claim 1, wherein the processor is further configured to pre-store a plat of a locale where the current scene is included.

4. The wearable device according to claim 1, wherein the processor is further configured to acquire, from a server, an evacuation orientation instruction, the evacuation orientation instruction comprises the evacuation orientation angle, and the evacuation orientation angle is an orientation angle with respect to the Geographic North.

5. The wearable device according to claim 1, wherein the processor is further configured to generate locally an evacuation orientation instruction, the evacuation orientation instruction comprises the evacuation orientation angle, and the evacuation orientation angle is an orientation angle with respect to the Geographic North.

6. The wearable device according to claim 2, wherein the speech player is configured to play the speech instruction when the visual guide identifier in the current scene shown on the display screen changes.

7. The wearable device according to claim 1, wherein the processor is further configured to:
obtain a mid-result according to the direction angle by a formula of o=i %360, where i denotes the direction angle, and o denotes the mid-result; and
compare the mid-result with preset value ranges to obtain a compared result, and generate the visual guide identifier according to the compared result.

8. The wearable device according to claim 7, wherein the processor is further configured to:
generate the visual guide identifier indicating “move forwards” when the mid-result is within a first value range from 0 to 45 or from 315 to 360;
generate the visual guide identifier indicating “turn rightwards” when the mid-result is within a second value range from 45 to 135;
generate the visual guide identifier indicating “turn backwards” when the mid-result is within a third value range from 135 to 225; or
generate the visual guide identifier indicating “turn leftwards” when the mid-result is within a fourth value range from 225 to 325.

9. A method for displaying an evacuation instruction, performed by a processor of a wearable device and comprising:
acquiring a current horizontal orientation angle;
acquiring a current geomagnetic deviation angle;
computing a current orientation angle according to the current horizontal orientation angle and the current geomagnetic deviation angle;
acquiring an evacuation orientation angle;
acquiring a direction angle according to the current orientation angle and the evacuation orientation angle; and
converting the direction angle into a visual guide identifier; and
displaying the visual guide identifier in a current scene shown on a display screen of the wearable device, such that a user moves according to the visual guide identifier and the current scene.

10. The method according to claim 9, further comprising:
converting the visual guide identifier into a speech instruction and playing the speech instruction.

11. The method according to claim 9, further comprising:
acquiring, from a server, an evacuation orientation instruction, wherein the evacuation orientation instruction comprises the evacuation orientation angle, and the evacuation orientation angle is an orientation angle with respect to the Geographic North.

12. The method according to claim 9, further comprising:
generating locally an evacuation orientation instruction, wherein the evacuation orientation instruction comprises the evacuation orientation angle, and the evacuation orientation angle is an orientation angle with respect to the Geographic North.

13. The method according to claim 10, further comprising:
playing the speech instruction when the visual guide identifier in the current scene changes.

14. The method according to claim 9, further comprising:
obtaining a mid-result according to the direction angle by a formula of: o=i %360, where i denotes the direction angle, and o denotes the mid-result; and
comparing the mid-result with preset value ranges to obtain a compared result, and generating the visual guide identifier according to the compared result.

15. The method according to claim 14, further comprising:
generating the visual guide identifier indicating “move forwards” when the compared result is within a first value range from 0 to 45 or from 315 to 360;
generating the visual guide identifier indicating “turn rightwards” when the compared result is within a second value range from 45 to 135;
generating the visual guide identifier indicating “turn backwards” when the compared result is within a third value range from 135 to 225; and
generating the visual guide identifier indicating “turn leftwards” when the compared result is within a fourth value range from 225 to 315.

16. A non-transitory computer-readable storage medium, having stored therein instructions that, when executed by a processor of a wearable device, causes the wearable device to perform a method for displaying an evacuation instruction, the method comprising:
acquiring a current horizontal orientation angle;
acquiring a current geomagnetic deviation angle;
computing a current orientation angle according to the current horizontal orientation angle and the current geomagnetic deviation angle;
acquiring an evacuation orientation angle;
acquiring a direction angle according to the current orientation angle and the evacuation orientation angle; and
converting the direction angle into a visual guide identifier; and
displaying the visual guide identifier in a current scene shown on a display screen of the wearable device, such that a user moves according to the visual guide identifier and the current scene.

17. The non-transitory computer-readable storage medium according to claim 16, wherein method further comprises:
converting the visual guide identifier into a speech instruction and playing the speech instruction.

18. The non-transitory computer-readable storage medium according to claim 17, wherein method further comprises:
playing the speech instruction when the visual guide identifier in the current scene changes.

19. The non-transitory computer-readable storage medium according to claim 16, wherein method further comprises:
obtaining a mid-result according to the direction angle by a formula of: o=i%360, where i denotes the direction angle, and o denotes the mid-result; and
comparing the mid-result with preset value ranges to obtain a compared result, and generating the visual guide identifier according to the compared result.

20. The non-transitory computer-readable storage medium according to claim 19, wherein method further comprises:
generating the visual guide identifier indicating “move forwards” when the compared result is within a first value range from 0 to 45 or from 315 to 360;
generating the visual guide identifier indicating “turn rightwards” when the compared result is within a second value range from 45 to 135;
generating the visual guide identifier indicating “turn backwards” when the compared result is within a third value range from 135 to 225; and
generating the visual guide identifier indicating “turn leftwards” when the compared result is within a fourth value range from 225 to 315.
